(19) United States
(12) Patent Application Publication
(10) Pub. No.: US 2014/0195370 A1
(43) Pub. Date: Jul. 10, 2014

(54) SYSTEMS AND METHODS FOR FEEDBACK ASSOCIATED WITH AN ELECTRONIC SHOPPING-CART

(71) Applicant: EBAY INC., San Jose, CA (US)

(72) Inventors: Jojy Devasia, San Jose, CA (US); Sarika Krishnan, San Jose, CA (US)

(73) Assignee: eBay Inc., San Jose, CA (US)

(21) Appl. No.: 13/737,605

(22) Filed: Jan. 9, 2013

(51) Int. Cl. G06Q 30/06

(52) U.S. Cl. CPC G06Q 30/0633
USPC 705/26.7; 705/26.8

(57) ABSTRACT

Methods and systems relating to feedback associated with an electronic shopping-cart are described. In some embodiments, item information associated with an item is received from a first user. The item is added to an electronic shopping-cart. A request to share the electronic shopping-cart with a second user is received. Shopping-cart information associated with the electronic shopping-cart is sent to the second user. Feedback from the second user is received. The feedback corresponds to the item in the electronic shopping-cart. The feedback is sent to the first user.

### TECHNICAL FIELD

The present disclosure generally relates to online shopping, and more specifically, to systems and methods relating to a shopping-cart feedback tool.

### BACKGROUND

While shopping online, a user can add items that he intends to purchase to an electronic shopping-cart. Once he has decided to purchase the items, the user can check out the shopping-cart and pay for the items in the shopping-cart. However, the user may need help deciding whether he should buy the items in the shopping-cart.

### BRIEF DESCRIPTION OF THE DRAWINGS

Some embodiments are illustrated by way of example, and not limitation, in the accompanying figures.

FIG. 1 is a network diagram depicting an example client-server system within which a shopping-cart feedback tool may be deployed, according to some embodiments;

FIG. 2 is a block diagram of example components of a shopping-cart feedback system, according to some embodiments;

FIG. 3 is a flowchart showing an example method for receiving feedback for an electronic shopping-cart, according to some embodiments;

FIG. 4 is an interface diagram of an example user interface for sharing an electronic shopping cart, according to some embodiments;

FIG. 5 is an interface diagram of an example user interface for providing feedback on an electronic shopping-cart, according to some embodiments;

FIG. 6 is an interface diagram of an example user interface for viewing feedback on an electronic shopping-cart, according to some embodiments;

FIG. 7 is an interface diagram of an example user interface for viewing feedback on an electronic shopping-cart, according to some embodiments;

FIG. 8 is an interface diagram of an example user interface for viewing an electronic shopping-cart, according to some embodiments; and

FIG. 9 is a block diagram of a machine in the example form of a computer system within which a set of instructions for causing the machine to perform any one or more of the methodologies discussed herein may be executed, according to some embodiments.

### DETAILED DESCRIPTION

Example systems and methods relating to feedback on an electronic shopping-cart are described. In the following description, for purposes of explanation, numerous specific details are set forth in order to provide a thorough understanding of example embodiments. It will be evident, however, to one skilled in the art that the present technology may be practiced without these specific details.

A shopping-cart feedback tool is provided. This tool enables a user to create one or more custom electronic shopping-carts that may be based on a theme, event, interest, and the like. Each cart may be shared with and edited by other users. The user may receive feedback from other users on an item included in the electronic shopping-cart and update the item if desired. Once the electronic shopping-cart is finalized, the user may checkout and purchase the items in the electronic shopping-cart. A user shopping online may took to a trusted social group to validate his purchase. The shopping-cart feedback took allows users to easily add items to customized shopping-carts and share the shopping-carts with their friends for feedback.

The shopping-cart feedback tool may be implemented as part of an online publication system or an e-commerce website that provides products and services for sale. A user may add one or more items that he intends to purchase to an electronic shopping-cart. The user may provide an identifier such as a name, an image, and the like, to correspond with the shopping-cart. The identifier may indicate a theme, event, purpose, or interest associated with the items in the shopping-cart. The user may create multiple shopping-carts and differentiate between them with the identifier. In this manner, the user may organize the items he is interested in. After creating the electronic shopping-cart, the user may share the shopping-cart with other users, such as his friends or family or the general public. By sharing the electronic shopping-cart with other users, the other users may view the items and information associated with the items, and provide feedback on the items. The shopping-cart feedback tool may share the shopping-cart with other users via an email, a social network site, or within the online publication site or e-commerce site. The other users with whom the shopping-cart is shared may provide feedback on the items in the shopping-cart. The other users may also view feedback left by others. The feedback may include comments on the item or a recommended item. The user may view the feedback provided by the other users and leave comments himself. If the other users recommended items, the user may swap items or add items to the electronic shopping-cart. After finalizing the electronic shopping-cart, the user may checkout and purchase the items in the shopping-cart. The user may also make the shopping-cart public. The shopping-cart feedback tool may make the shopping-cart public by publishing information associated with the electronic shopping-cart and the items in the shopping-cart. The feedback associated with the electronic shopping-cart may also be published. In this manner, the feedback on the items in the electronic shopping-cart may be available to users of the online publication site or e-commerce site. The shopping-cart feedback tool may also allow the users who provide feedback on the electronic shopping-cart to create an electronic shopping-cart for themselves with the items included in the shopping-cart that they provided feedback on.

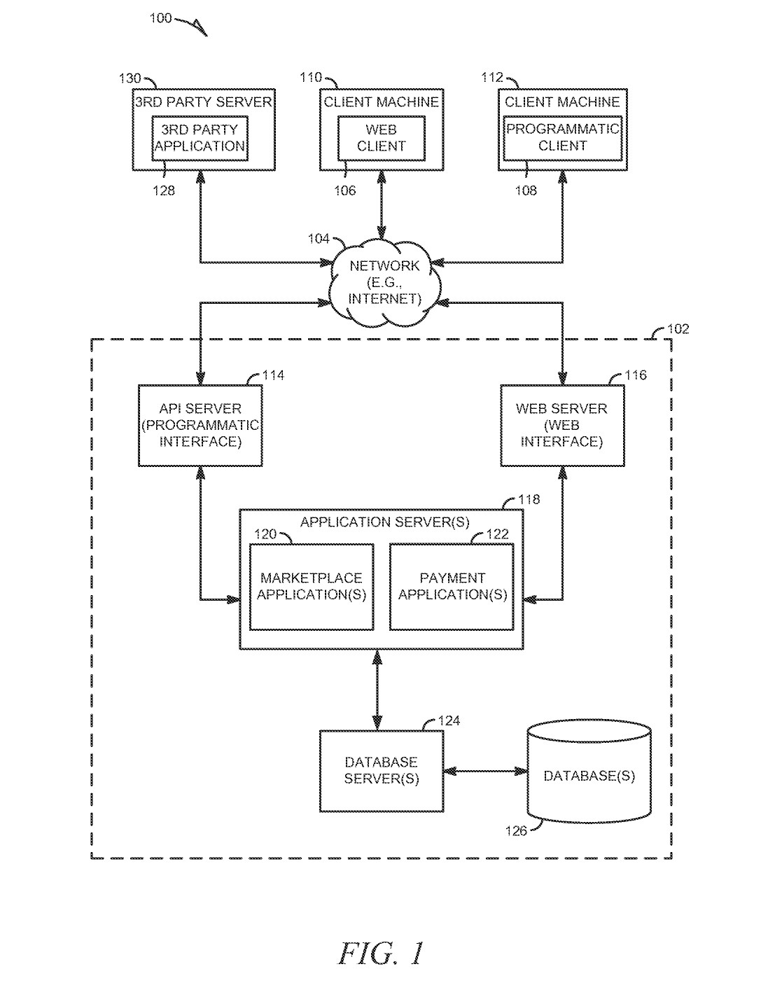

FIG. 1 is a network diagram depicting an example client-server system 100 within which a shopping-cart feedback tool may be deployed. A networked system 102, in the example forms of a network-based marketplace or publication system, provides server-side functionality, via a network 104 (e.g., the Internet, Wide Area Network (WAN), etc.) to one or more clients. FIG. 1 illustrates, for example, a web client 106 (e.g., a browser), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments of the present disclosure is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third party. The third-party website may, for example, provide one or more promotional, marketplace, or payment functions that are supported by the relevant applications of the networked system 102.

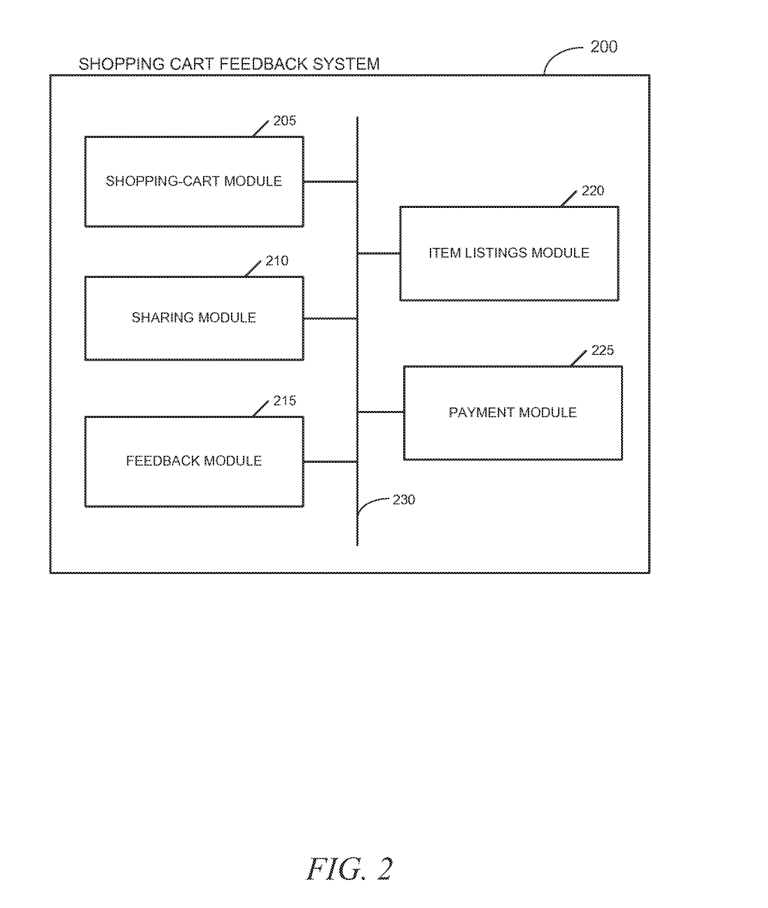

FIG. 2 is a block diagram of example components of a shopping-cart feedback system 200, which may be a system within the networked system 102 of FIG. 1. In some embodiments, the shopping-cart feedback system 200 may be included application servers 118 of FIG. 1. In various embodiments, the shopping-cart feedback system 200 may implement computer programs, logic, applications, methods, processes, or software to provide user transaction information relevant to a particular transaction. The components of the shopping-cart feedback system 200 may include components such as a shopping-cart module 205, a sharing module 210, a feedback module 215, an item listings module 220, and a payment module 225. A communication bus 230 may be coupled to the various modules and components in the shopping-cart feedback system 200, thereby allowing the modules and components to communicate with one another. Communication bus 230 may use any communication protocol and any communication media.

The shopping-cart module 205 may be a hardware-implemented module which may be configured to manage, organize, create, and/or customize electronic shopping-carts associated with a user of an online publication system. The electronic shopping-cart may include items that a user wishes to purchase. The user may use the electronic shopping-cart to gather items and then purchase them at checkout. The shopping-cart module 205 may also be configured to add or remove items based on a user request. A user may create multiple electronic shopping-carts and customize them by naming them. The shopping-cart module 205 may also be configured to present and display information associated with an electronic shopping-cart.

The sharing module 210 may be a hardware-implemented module which may be configured to send and share an electronic shopping-cart with another user. The sharing module 210 may also be configured to manage information associated with the other user. The electronic shopping-cart may be shared with another user who is a friend of the user who created the shopping-cart. The electronic shopping-cart may be shared via an email or a social networking site.

The feedback module 215 may be a hardware-implemented module which may be configured to receive, monitor, and/or manage feedback provided by any user for an electronic shopping-cart. Users may provide feedback regarding the item or items in the electronic shopping cart. The feedback module 215 may also be configured to send the feedback to the users. The feedback module 215 may also be configured to manage a user interface for displaying and receiving feedback from users.

The item listings module 220 may be a hardware-implemented module which may be configured to manage information associated with an item listing. An item listing includes a listing for a product or service for sale on an online publication system. The information associated with an item listing includes, but is not limited to, an item name, an item price, item details, item specifications, item pictures, item thumbnail, item reviews, bidding information, seller name, shipping information, and seller reviews.

The payment module 225 may be a hardware-implemented module which may be configured to receive and manage payment information associated with an electronic shopping-cart upon checkout. Payment information includes, but is not limited to, an amount, a method of payment, payment account information, and a billing address. The payment module 225 may receive payment information from a user after the user checks out the electronic shopping-cart.

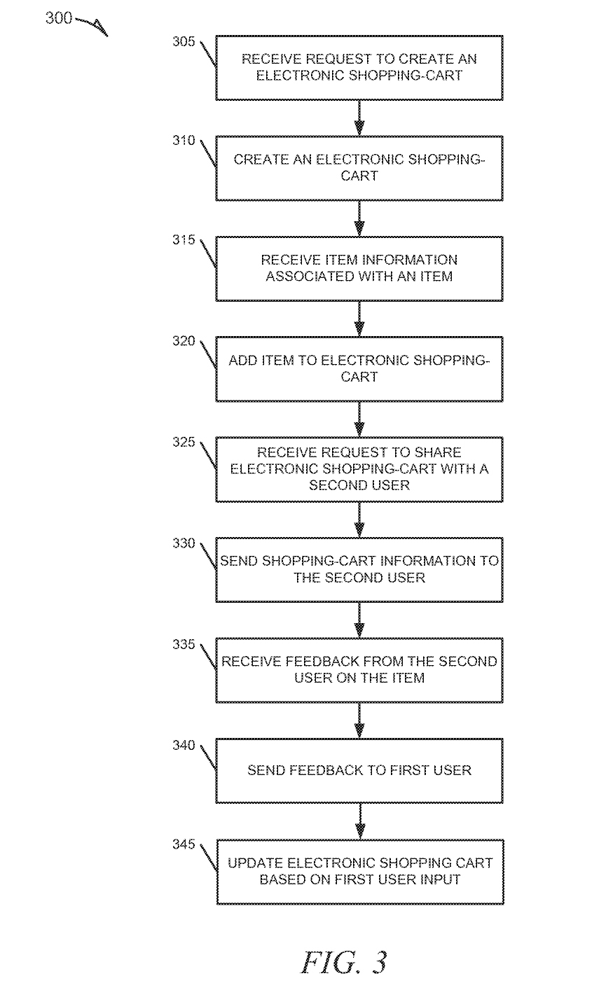

FIG. 3 is a flow chart showing an example method 300 for receiving feedback for an electronic shopping-cart. The method 300 may be performed using the shopping-cart feedback system 200 of the online publication system, as shown in FIG. 2.

In operation 305, the shopping-cart module 205 receives a request to create an electronic shopping-cart. The request is received from a user of an online publication system. The request to create an electronic shopping-cart may include an identifier corresponding to the electronic shopping-cart. The identifier may include a name. The name may be indicative of a theme, purpose or event corresponding to the items in the electronic shopping-cart. For example, a user may request to create an electronic shopping-cart with the name ‘Camera.’ The user may intend to use this shopping-cart to purchase items related to a camera, such as a digital camera, a camera lens, a memory stick for the camera, and the like. In another example, the user may request to create an electronic shopping-cart with the name ‘Anniversary.’ In this case, the user may intend to user the shopping-cart to purchase items for an anniversary event. In some embodiments, the identifier may include an icon or an image that is indicative of a theme, a purpose, or an event corresponding to the items in the electronic shopping cart.

In operation 310, the shopping-cart module 205 creates an electronic shopping-cart. The shopping-cart module 205 may associate an identifier with the electronic shopping-cart if one is included in the request to create an electronic shopping-cart. A user may create multiple shopping-carts and he may want to differentiate between them by providing an identifier such as a name. The shopping-cart module 205 may display the identifier in a user interface to indicate to the user which shopping-cart he is viewing or working with.

In operation 315, the shopping-cart module 205 receives item information associated with an item. The item information includes, but is not limited to, an item name, an item price, item details, item specifications, item pictures, item thumbnail, item reviews, bidding information, seller name, shipping information, seller reviews, and the like. The item may be an item that the user intends to purchase. The item may include a product or service for sale. In some embodiments, the user may be able to buy the item by paying the price associated with the item. In other embodiments, the user may have to bid on the item, and if his bid is the winning bid then he may buy the item.

In operation 320, the shopping-cart module 205 adds the item to the electronic shopping-cart. The user may add multiple items to the shopping-cart. Adding items to the electronic shopping-cart allows the user to check out and purchase all the items in the shopping cart in the same transaction. The user may be able to add an item that is only available for bidding. In that case, the item may be automatically removed from the electronic shopping-cart if the user does not have the winning bid. The user may remove items from the electronic shopping-cart as well.

In operation 325, the sharing module 210 receives a request to share the electronic shopping-cart with a second user. The request to share the electronic shopping-cart may be received from a first user. The first user is a user who created the electronic shopping-cart on an online publication site. The second user may be another user who is associated with or in contact with the first user, such as a friend or relative of the first user. In some embodiments, the second user is a person that the first user is familiar with. The second user may be friends with the first user in a social networking site. In other embodiments, the second user is any person of the general public. In some embodiments, the first user and the second user are users of the online publication site. In other embodiments, the first user is a user of the online publication system, and the second user is not. The request to share the electronic shopping-cart may include information corresponding to the second user with whom the shopping-cart is to be shared. The first user may request to share the electronic shopping-cart with multiple users at a time. In this case, all the users with whom the shopping-cart is shared may view the activities of the other users, where the activities are associated with the electronic shopping-cart. The first user may also request to share multiple electronic shopping-carts at a time.

The request to share the electronic shopping-cart may specify a manner by which the shopping-cart is to be shared. In some embodiments, the first user may specify how he wants the shopping-cart to be shared. The sharing module 210 may share the shopping-cart via an email or a social networking si e. In other embodiments, the sharing module 210 may share the shopping-cart via a default manner.

The request to share the electronic shopping-cart may include a username or an email of the second user. The username of the second user may be a username that the second user uses on the online publication system or on a social networking site. The request to share may include a message from the first user for the second user.

In operation 330, the sharing module 210 may send shopping-cart information to the second user. The shopping-cart information is associated with the electronic shopping-cart, and includes, but is not limited to, a name of the electronic shopping-cart, item information associated with item(s) in the electronic shopping-cart, and a name of the first user. The sharing module 210 may send the shopping-cart information to the second user using a variety of manners. In some embodiments, the sharing module 210 sends the shopping-cart information to the second user via an email. In other embodiments, the sharing module 210 sends the shopping-cart information to the second user via asocial networking site. In this case, the sharing module 210 may send a message to the second user within a social networking site. The sharing module 210 may publish the shopping-cart information as a status update of the first user. The sharing module 210 may also send a message to the second user within the online publication system, if the second user is a user of the online publication system. The email or message or status update also includes a link to a user interface where the second user may provide feedback. The second user may select or click on the link. Selecting the link directs the second user to a user interface within the online publication system where the second user may provide feedback on the item in the electronic shopping-cart. In an example embodiment, the sharing module 210 includes a message from the first user to the second user.

In operation 335, the feedback module 215 receives feedback from the second user on the item. The second user provides feedback via a user interface that is managed by the feedback module 215. The feedback includes comments that the second user has about the item in the electronic shopping cart. The second user may provide feedback for each item in the electronic shopping-cart. In some embodiments, the second user may provide feedback on the electronic shopping-cart in general, without associating feedback with an item in the electronic shopping-cart. The second user may also recommend items when providing feedback. The recommended item may be an item available for purchase on the online publication system or on another website. The second user may suggest an item that the first user should consider buying, or the second user may suggest a similar item that the first user should buy instead of the item in the electronic shopping-cart. The second user may also view feedback provided by other users. The other users may be users with whom the first user shared the shopping-cart.

In operation 340, the feedback module 215 sends the feedback to the first user. The feedback module 215 may send the feedback to the first user via an email. In other embodiments, the feedback module 215 may send a message to the first user within the online publication system. The first user may view the feedback via the user interface managed by the feedback module 215. The first user may view the latest feedback associated with all the items in the electronic shopping-cart. The first user may also view all the comments associated with a certain item in the electronic shopping-cart. The user interface may include information about the user who provided the feedback. For example, the user interface may display the user's name and the date the feedback was provided.

The first user may also view recommended items included by the second user in the feedback. The feedback module 215 may display information associated with the recommended item in the user interface. For example, information associated with the recommended item such as a name, a price, specifications, an image, and the like may be displayed. A link to a listing of the recommended item may also be provided. As discussed above, the second user may recommend an item that the first user should buy instead of the item in the electronic shopping-cart. In this case, the feedback module 215 may provide an option to swap items. In an example embodiment, the user interface displays the recommended item along with a button that allows the first user to swap the item in the shopping-cart with the recommended item.

The second user may also recommend an item that the first user should add to the shopping-cart. In this case, the feedback module 215 may provide an option to add the recommended item. In an example embodiment, the user interface displays the recommended item along with a button that allows the first user to add the recommended item to the shopping-cart. In some embodiments, the first user may swap with the recommended items or add the recommended items to the shopping-cart if the recommended item is available for sale on the online publication system. In an example embodiment, the first user is directed to an e-commerce site where the recommended item is available for sale. In another example embodiment, the first user may purchase the recommended item by adding it to the electronic shopping-cart on the online publication site, even though the recommended item is available for purchase through another e-commerce site. In this case, the online publication site may have an arrangement with the e-commerce site that allows users to purchase their items on the online publication site. Such arrangements may include a shared revenue arrangement and the like.

In an example embodiment, the first user may also provide comments on the electronic shopping-cart. The comments provided by the first user may be viewed by the users with whom the electronic shopping-cart is shared. The feedback module 215 may send an email or message, as discussed above, notifying the second user that the first user or other users provided comments on the electronic shopping-cart. The second user may view the first user's comments and provide additional comments on the electronic shopping-cart.

In some embodiments, the second user may create an electronic shopping-cart with the items in the first user's electronic shopping-cart. The user interface may display a button that allows the second user to create an electronic shopping-cart. If items in the first user's shopping-cart are in stock, then the items are added to the second user's shopping-cart. If the items are not in stock, then alternate similar items may be suggested to the second user, which he may add to his electronic shopping-cart. The second user may customize his electronic shopping-cart by adding or removing items. He may also share his shopping-cart and receive feedback as described herein.

In operation 345, the shopping-cart module 205 updates the electronic shopping-cart based on an input from the first user. If the first user swaps items with the recommended items, then the shopping-cart module 205 adds the recommended items to the shopping-cart and removes the items that the first user wants to swap with. If the first user adds recommended items, then the shopping-cart module 205 adds the recommended items to the electronic shopping-cart. The first user may also remove items from the electronic shopping-cart or add other items to the shopping-cart. Based on these inputs from the first user the shopping-cart module 205 updates the electronic shopping-cart for check out. A notification email or message may be sent to the users who provided feedback on the electronic shopping-cart when the first user updates the electronic shopping-cart.

The shopping-cart module 205 also facilitates check out of the electronic shopping-cart. After the first user has finalized the shopping-cart, he may check out and purchase the items in the shopping-cart. In some embodiments, the shopping-cart module 205 may make the cart public. For example, the shopping-cart module 205 may publish the shopping-cart and the corresponding feedback in the online publication system, if the first user selects to do so. In this manner, the electronic shopping-cart and the feedback may be available to all users of the online publication system. The shopping-cart module 205 may display a button that allows the user to check out, and a button that allows the user to make the cart public. A notification email or message may be sent to the users, who provided feedback on the electronic shopping-cart, informing them that the first user finalized the shopping-cart and purchased the items.

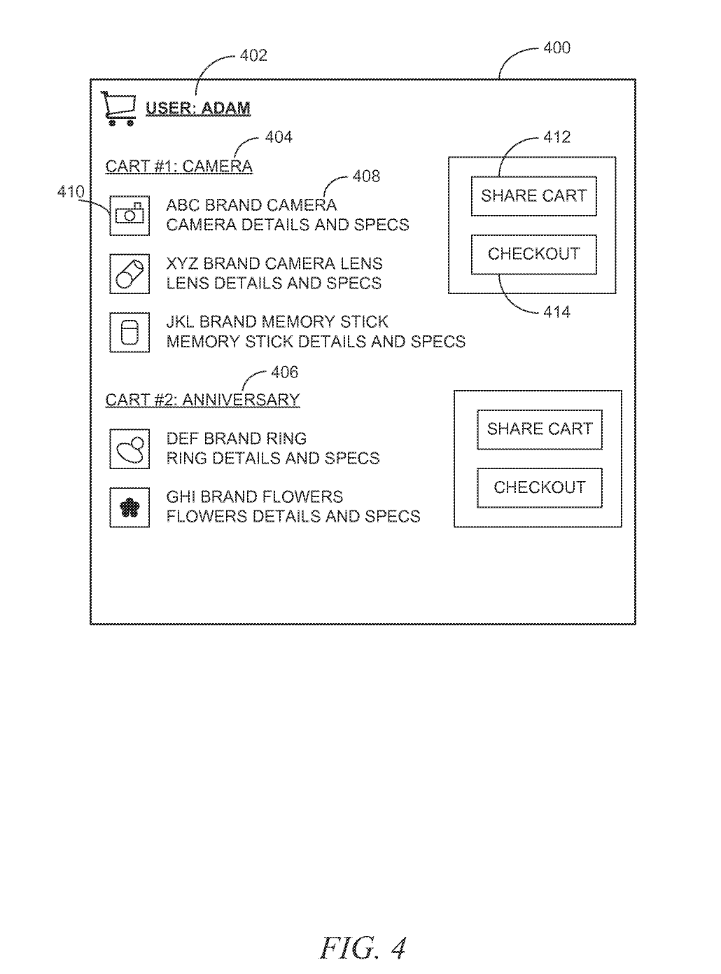

FIG. 4 is an interface diagram of an example user interface 400 for sharing an electronic shopping cart. User interface 400 may be an interface to manage and share multiple electronic shopping-carts for an account associated with an online publication system. User interface 400 includes a user identifier 402 for the user associated with the account. User interface 400 includes shopping-cart 404 and shopping-cart 406. Item 408 is displayed as an item in shopping-cart 404. Image 410 is displayed as associated with item 408. As discussed above, a name may be associated with the shopping-cart. The name may indicate a purpose or theme or event for the shopping-cart. For example, user interface 400 illustrates user Adam having two shopping-carts. Shopping-cart 404 is named “Camera” and shopping-cart 406 is named “Anniversary.” Shopping-cart 404 contains items related to a camera, such as ABC Brand Camera, XYZ Brand Camera Lens, and the like. Shopping-cart 406 contains items related to an anniversary such as DEF Brand Ring, and GHI Brand Flowers. User interface 400 also displays button 412 and button 414 as associated with shopping-cart 404. Upon selecting button 412, the user may share the information associated shopping-cart 404. Upon selecting button 414, the user may checkout and proceed to purchase the items in shopping-cart 404.

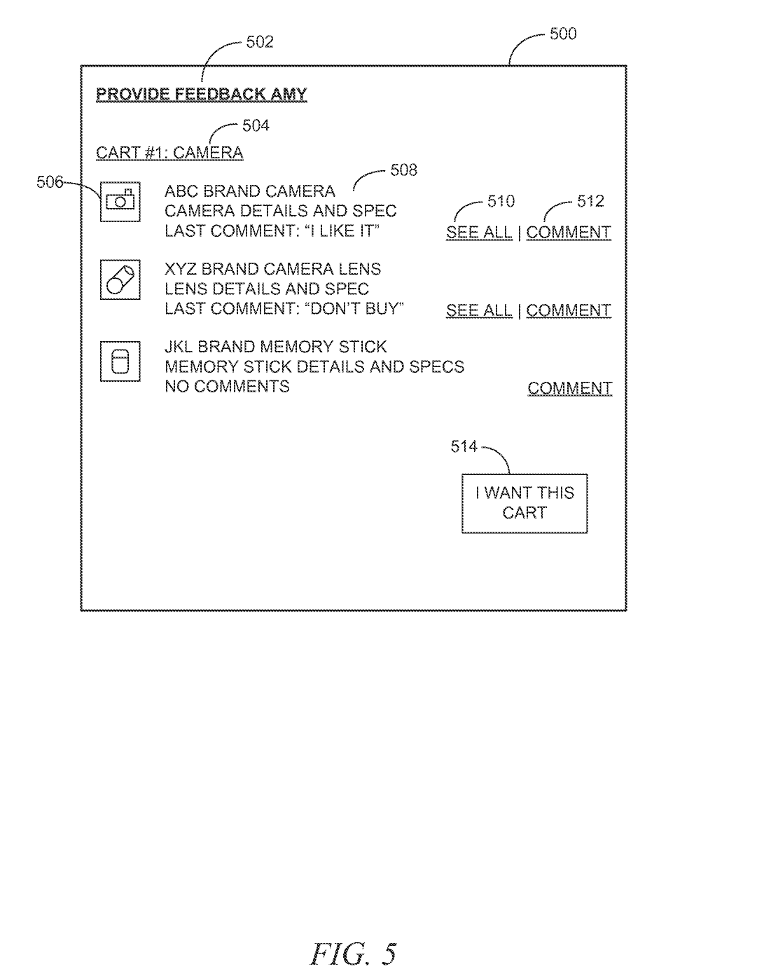

FIG. 5 is an interface diagram of an example user interface 500 for providing feedback on an electronic shopping-cart. User interface 500 may be an interface to receive and manage feedback from a user. In this case, the first user shared Cart#1 Camera. User interface 500 includes a user identifier 502 for the user that is providing feedback. Shopping-cart 504 is included in user interface 500 as the shopping-cart that user 502 is providing feedback for. Item 508 is included as an item in shopping-cart 504. Image 506 is displayed as associated with item 508. Information associated with item 508 is displayed. Information for item 508 includes the name for item 508, details for item 508, and the latest feedback available for item 508. For example, user interface 500 illustrates an interface for user Amy to provide feedback for shopping-cart 504 named Camera. User Amy may provide feedback for items in shopping cart 504. Link 510 allows user Amy to view all feedback associated with item 508. Link 512 allows Amy to provide feedback on item 508. Although links 510 and 512 are presented as links, it is understood that they may be presented as buttons. Button 514 allows the user to create a shopping-cart with the items in shopping-cart 504 as discussed above.

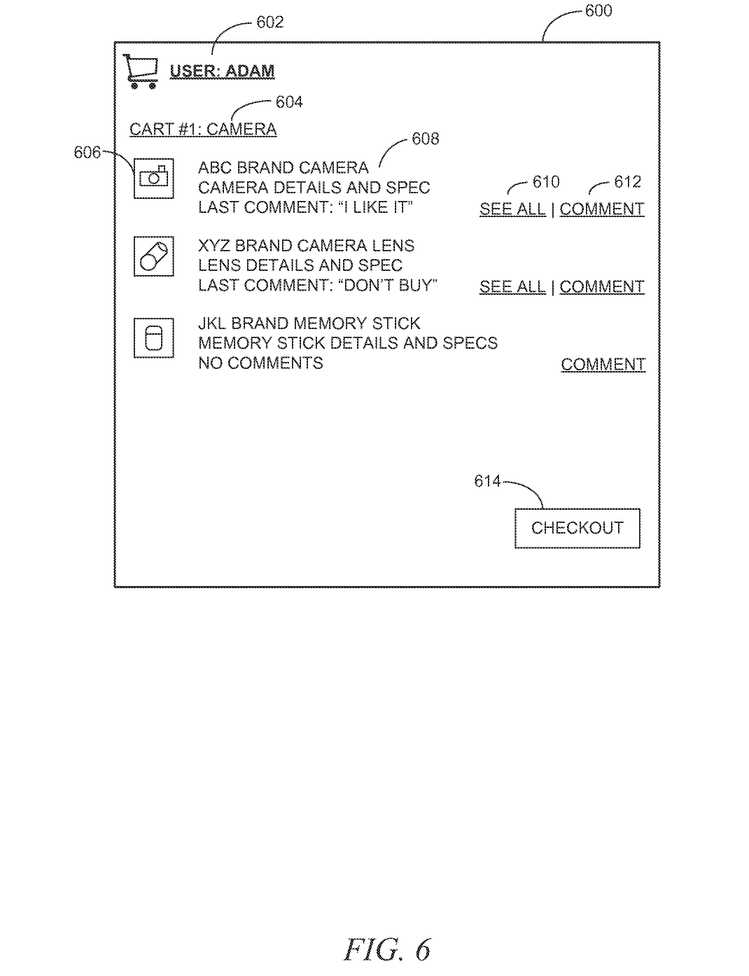

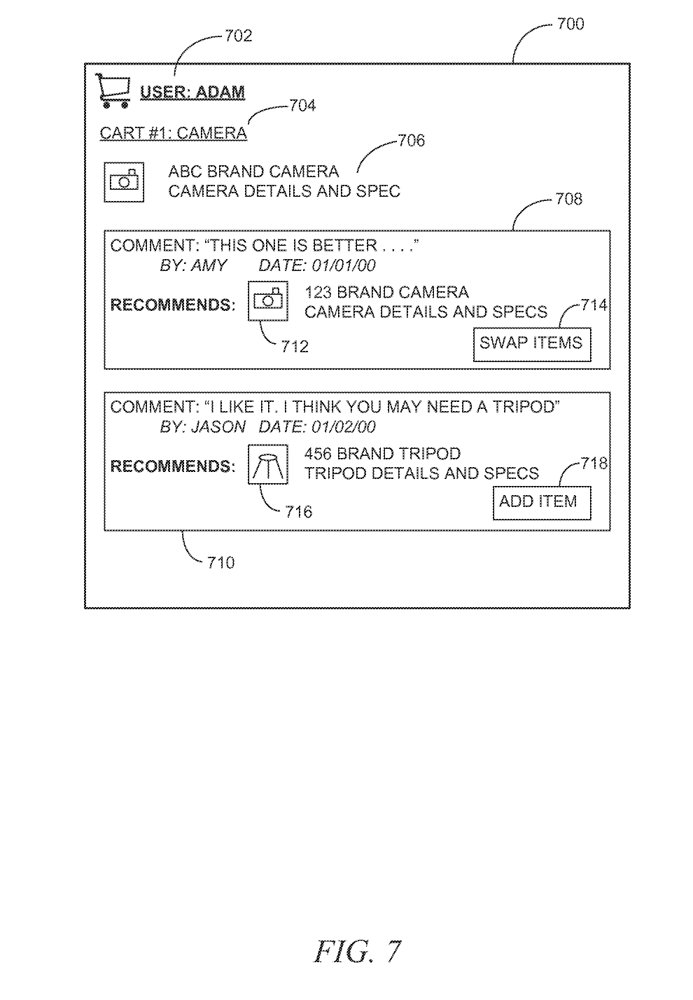

FIG. 6 is an interface diagram of an example user interface 600 for viewing feedback on an electronic shopping-cart. User interface may be an interface to provide feedback to a user. User interface 600 includes a user identifier 602 for the user that is viewing the feedback. Shopping-cart 604 is included in user interface 600 as the shopping-cart that user 602 is viewing feedback for. User interface 600 includes item 608 as an item in shopping-cart 604. Image 606 is displayed as associated with item 608. Information associated with item 608 is displayed. This information includes the name for item 608, the details for item 608, and the latest feedback regarding item 608. The user may view all feedback associated with shopping-cart 604 by selecting link 610. Selecting link 610 directs the user to user interface 700 in FIG. 7. The user may provide feedback on shopping-cart 604 by selecting link 612. The user may also checkout and proceed to purchase the items in shopping-cart 604 by selecting button 614. Although links 610 and 612 are illustrated as links, it is understood that they may be presented as buttons in user interface 600.

FIG. 7 is an interface diagram of an example user interface 700 for viewing feedback on an electronic shopping-cart. User interface 700 may be an interface to view feedback associated with an item in a shopping-cart. User interface 700 includes a user identifier 702 thr the user that is viewing the feedback. Shopping-cart 704 is included in user interface 700 as the shopping-cart that user 702 is viewing feedback for. Information associated with item 706 is included. Item 706 is the item that the user is viewing feedback for. User interface 700 includes feedback 708 associated with item 706. Feedback 708 includes a comment provided by a user, a name of the user who provided the comment, and a date that the comment was provided on. Feedback 708 also includes a recommended item 712. In this case, user Amy recommended item 712, and that user Adam should buy recommended item 712 instead of the item 706. User interface 700 displays button 714 as associated with feedback 708. Selecting button 714 allows the user to swap recommended item 712 with item 706 as discussed above. User interface 700 also includes feedback 710 associated with item 706. Feedback 710 includes recommended item 716. In this case, user Jason recommended item 716, and that user Adam should add it to shopping-cart 704. User interface 700 displays button 718 as associated with feedback 710. Selecting button 718 allows the user to add recommended item 716 to shopping-cart 704 as discussed above.

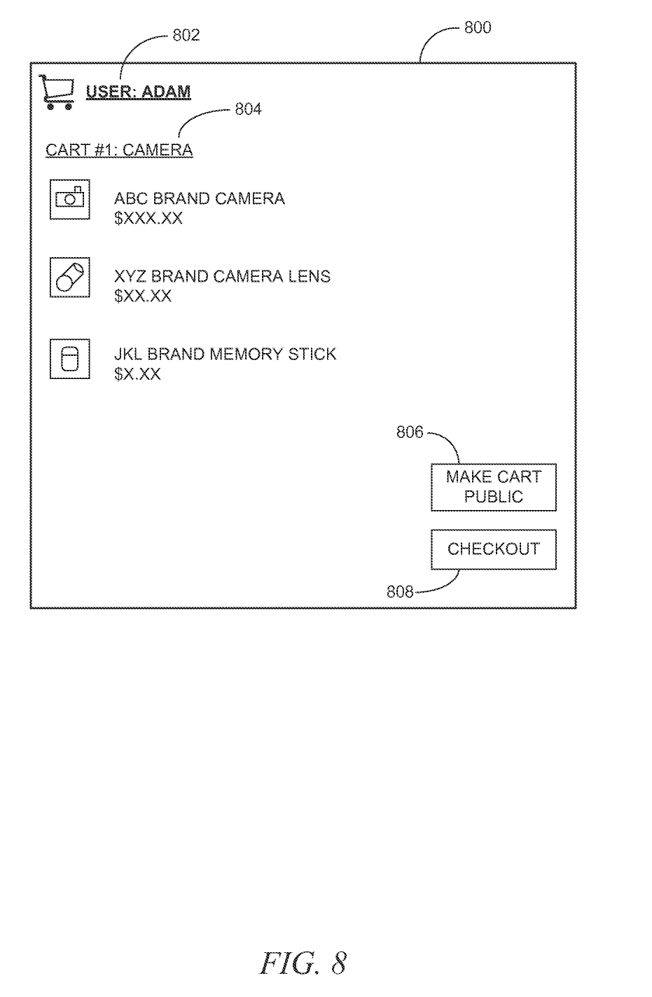

FIG. 8 is an interface diagram of an example user interface 800 for viewing an electronic shopping-cart. User interface 800 may be an interface to finalize and checkout the shopping-cart. User interface 800 includes a user identifier 802 for the user with whom the shopping-cart is associated. Shopping-cart 804 is included in user interface 800 as the shopping-cart that user 802 finalized and intends to checkout. Button 806 and 808 are also included. Selecting button 806 allows the user to make the shopping-cart 804 public as discussed above. Selecting button 808 directs the user to checkout and proceed to purchase the items in the shopping-cart 804.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

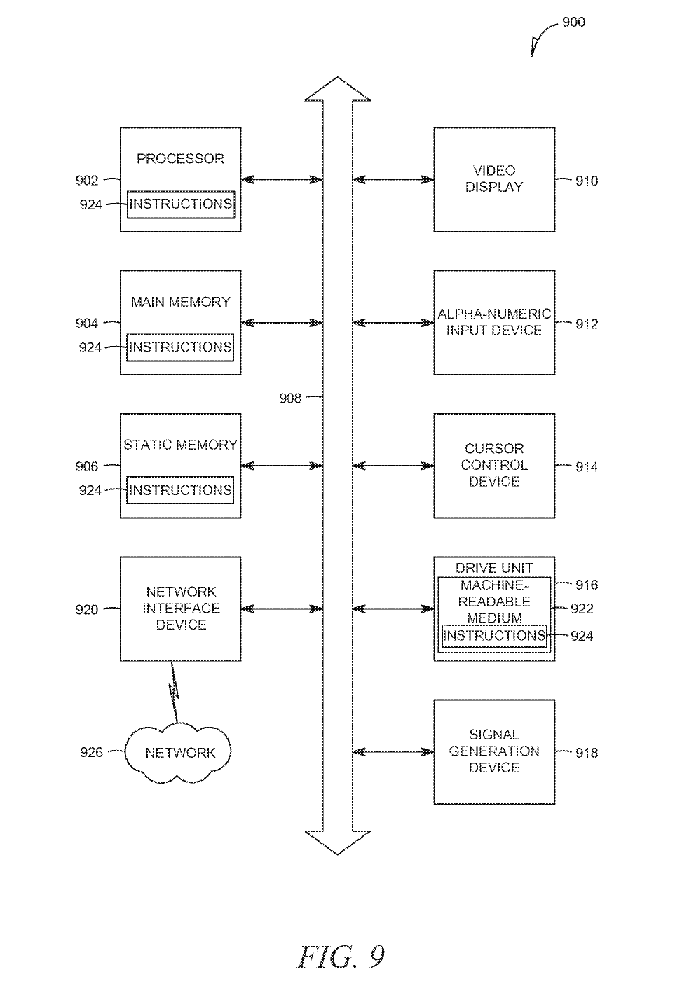

FIG. 9 is a block diagram of a machine in the example form of a computer system 900 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (VI) navigation device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions and data structures (e.g., software) 924 embodying or used by any one or more of the methodologies or functions described herein. The instructions 924 may also reside, completely or at least partially, within the main memory 904, static memory 906, and/or within the processor 902 during execution thereof by the computer system 900, with the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the present disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “mechanism” merely for convenience and without intending to voluntarily limit the scope of this application to any single embodiment or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system for providing feedback associated with an electronic shopping-cart, the system comprising:
a hardware-implemented shopping-cart module configured to:
receive, from a first user, item information associated with an item to add to the electronic shopping-cart of the first user, and
add the item to the electronic shopping-cart;
a hardware-implemented sharing module configured to:
receive a request to share the electronic shopping-cart with a second user, and
send shopping-cart information associated with the electronic shopping-cart to the second user; and
a hardware-implemented feedback module configured to:
receive feedback from the second user, the feedback corresponding to the item in the electronic shopping-cart, and
send the feedback to the first user.

2. The system of claim 1, wherein the hardware-implemented shopping-cart module is further configured to:
receive a request to create the electronic shopping-cart;
receive an identifier corresponding to the electronic shopping-cart; and
associate the identifier with the electronic shopping-cart.

3. The system of claim 1, wherein the request to share the electronic shopping-cart includes a username of the second user.

4. The system of claim 1, wherein the sharing module is further configured to send the shopping-cart information to the second user via a social networking site.

5. The system of claim 1, wherein the sharing module is further configured to send an email to the second user, the email including the shopping-cart information.

6. The system of claim 1, wherein the feedback from the second user includes a recommendation associated with a second item.

7. The system of claim 6, wherein the shopping-cart module is further configured to receive, from the first user, a request to add the second item to the electronic shopping-cart.

8. The system of claim 1, wherein the shopping-cart module is further configured to:
receive a request to create a second electronic shopping-cart;
create the second electronic shopping-cart;
receive, from the first user, second item information associated with a second item to add to the second electronic shopping-cart; and
add the second item to the second electronic shopping-cart.

9. A method of providing feedback associated with an electronic shopping-cart, the method comprising:
receiving, from a first user, item information associated with an item to add to the electronic shopping-cart of the first user;
adding the item to the electronic shopping-cart;
receiving a request to share the electronic shopping-cart with a second user;
sending shopping-cart information associated with the electronic shopping-cart to the second user;
receiving feedback from the second user, the feedback corresponding to the item in the electronic shopping-cart; and
sending the feedback to the first user.

10. The method of claim 9, further comprising:
receiving an identifier corresponding to the electronic shopping-cart, the identifier corresponding to a theme of the item in the electronic shopping-cart; and
associating the identifier with the electronic shopping-cart.

11. The method of claim 9, wherein the item is a product for sale on a network-based publication system.

12. The method of claim 9, wherein sending the shopping-cart information to the second user includes sending the shopping-cart information via a social networking site.

13. The method of claim 9, wherein sending the shopping-cart information to the second user includes sending an email to the second user, the email including the shopping-cart information.

14. The method of claim 9, wherein the feedback from the second user includes a recommendation associated with a second item.

15. The method of claim 9, further comprising:
receiving, from the first user, a request to add the second item to the electronic shopping-cart.

16. A non-transitory machine-readable medium storing instructions that, when executed by one or more processors, cause the one or more processors to perform operations comprising:
receiving, from a first user, item information associated with an item to add to an electronic shopping-cart;
adding the item to the electronic shopping-cart;
receiving a request to share the electronic shopping-cart with a second user;
sending shopping-cart information associated with the electronic shopping-cart to the second user;
receiving feedback from the second user, the feedback corresponding to the item in the electronic shopping-cart; and
sending the feedback to the first user.

17. The non-transitory machine-readable medium of claim 16, wherein sending the shopping-cart information to the second user includes sending the shopping-cart information via a social networking site.

18. The non-transitory machine-readable medium of claim 16, wherein sending the shopping-cart information to the second user includes sending an email to the second user, the email including the shopping-cart information.

19. The non-transitory machine-readable medium of claim 16, wherein the feedback from the second user includes a recommendation for a second item.

20. The non-transitory machine-readable medium of claim 19, wherein the instructions cause the one or more processors to perform further operations comprising:
receiving, from the first user, a request from to add the second item to the electronic shopping-cart.
